(19) United States
(12) Patent Application Publication
(10) Pub. No.: US 2004/0026821 A1
(43) Pub. Date: Feb. 12, 2004

(54) Method of manufacturing an abdominal belt and mould

(76) Inventor: Joon-Suk Chae, Seoul (KR)

Correspondence Address: PARK & SUTTON LLP, 3255 WILSHIRE BLVD, SUITE 1110, LOS ANGELES, CA, 90010, US

(21) Appl. No.: 10/433,274

(22) PCT Filed: Apr. 19, 2002
(86) PCT No.: PCT/KR02/00721

(30) Foreign Application Priority Data
Jun. 16, 2001 (KR) 2001-0063558

(51) Int. Cl. B29C 65/00

(52) U.S. Cl. 264/248

(57) ABSTRACT

The present method of manufacturing an abdominal belt is characterized by comprising the stage of manufacturing and preparation (S101) for manufacturing mould and preparing material, arranging stage of material in lower mould produced in the above stage of manufacturing and preparation (S102), binding stage of lower outside skin, lower inside skin, upper inside skin, upper outside skin together by putting the above lower mould into large welding device of high frequency and descending upper mould then heating material by the heating part of high frequency of upper mould (S103), separating stage of mutually adhered unfinished product from lower mould (S104), binding stage of unadhered part in separated unfinished product using a small welding device of high frequency (S105), attaching stage of velcro tape to the above unfinished product (S106), the stage of performing finishing work (S107), and attaching stage of enforcement band to the above product (S108).

### TECHNICAL FIELD

The present invention relates to the method of manufacturing an abdominal belt, and mould that is used for the former, more particularly, it relates to method of manufacturing an abdominal belt and mould, which can adjust extended length of latex hose equally and bind outer skin together using high frequency device.

### BACKGROUND ART

“An abdominal belt used for protecting and treating a lumbar” is introduced in Patent application No. 1998-60510 of this applicant. However, there were very difficult disadvantages in production because the above abdominal belt used for protecting and treating a lumbar produced an abdominal belt using a sewing method.

“An abdominal belt used for protecting and treating a lumbar, in which double sealing is possible” is introduced in Utility Model Registered No. 2001-3131 of this applicant. However, there were complicated disadvantages of producing method in the above abdominal belt used for protecting and treating a lumbar, in which double sealing is possible.

### DETAILED DESCRIPTION OF THE INVENTION

The purpose of this invention is preventing an elastic tube from being damaged by adhering outer skin to inside skin together using adhering method of high frequency, and it relates to manufacturing method of an abdominal belt and mould to simplify the adhering process of outer skin.

### BRIEF DESCRIPTION OF DRAWINGS

FIG. 1 is a flow chart illustrating manufacturing process of an abdominal belt according to the invention;

FIG. 2a is a perspective view illustrating lower mould of the mould according to the invention;

FIG. 2b is a perspective view illustrating upper mould of the mould according to the invention;

FIG. 3 is a perspective view illustrating the state of reinforcement band attached to an abdominal belt

### BEST MODE FOR CARRYING OUT THE INVENTION

The example of a manufacturing method of an abdominal belt in accordance with this invention to achieve the above-mentioned purpose is characterized by comprising the stage of production and preparation for producing mould and preparing material, the arranging stage of material in the lower mould produced in the above production and preparation stage, the binding stage of lower outside skin, lower inside skin, upper inside skin, and upper outside skin together by putting the above lower mould into a large welding device of high frequency and descending upper mould and heating material by the heating part of high frequency of the upper mould, the separating stage of unfinished product adhered together from lower mould, the binding stage of unadhered part in the separated unfinished products using small welding device of high frequency, the attaching stage of velcro tape to the above unfinished products, the stage in which finishing work is performed, and the stage of attaching an enforcement band to the above product.

In the above stage of production and preparation, it is characterized by manufacturing a upper mould, cutting out lower outside skin, lower inside skin, upper inside skin, upper outside skin and insulating paper to fixed shapes and sizes, and marking on an elastic tube the part that is get caught on a ring of lower mould after cutting the elastic tube to a fixed length.

In the stage of arranging material in a lower mould, it is characterized by laying insulating paper on upper mould, arranging lower outside skin and lower inside skin on the above insulating paper in order, applying a lubricant to the above lower inside skin, extending the length of an elastic tube to the ring of above lower mould and hanging the elastic tube on the above ring so that the mark on elastic tube can locate on the above ring, applying lubricant to the above elastic tube again, and arranging upper inside skin and upper outside skin on the above elastic tube in order.

The above lubricant is characterized by cornstarch.

In the mould for manufacturing an abdominal belt, the invention is characterized by the lower mould in which a place is marked to arrange lower outside skin, a great number of rings are arranged in upper and lower parts, a pin is arranged to fix fixing member of an elastic tube, the heating part of the above upper mould is taken a zigzag shape and lower outside skin and upper outside skin around the elastic tube are adhered together, and the outer part of the ring of the lower mould is formed to be not adhered.

Referring to the attached drawings, the desirable example of this invention will be described in detail.

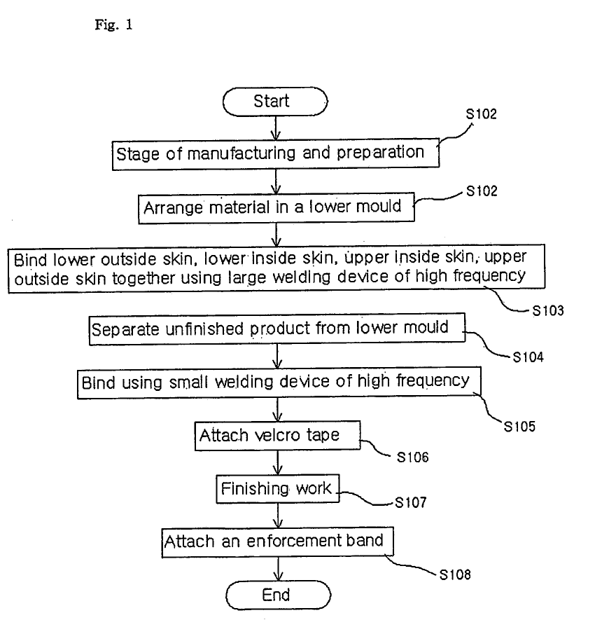

With reference to FIG. 1, manufacturing method of an abdominal belt according to the invention makes manufacturing preparation (S101) preparing for mould production and material, arranges material in lower mould produced in the above stage of manufacturing and preparation (S111),(S102), binds lower outside skin, lower inside skin, upper inside skin and upper outside skin together by putting the above lower mould into large welding device of high frequency and descending the upper mould and heating the material by the heating part of high frequency of upper mould (S103), separates mutually adhered unfinished products from the lower mould (S104), attaches velcro tape to the above unfinished product (S106) after binding unadhered part in separated unfinished product using a small welding device of high frequency (S105), performing finishing work (S107), attaches an enforcement band to the above unfinished product (S108) and completes product.

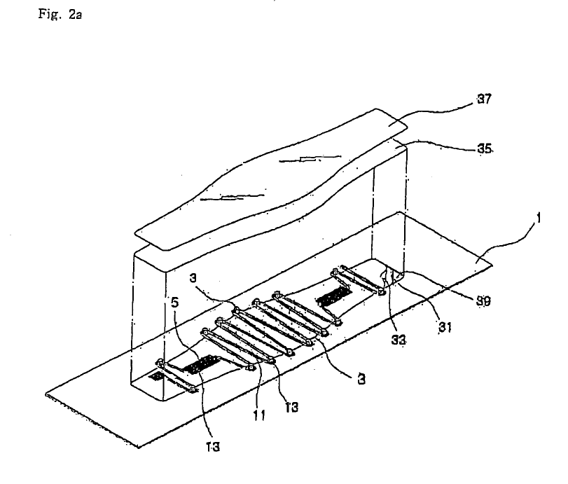

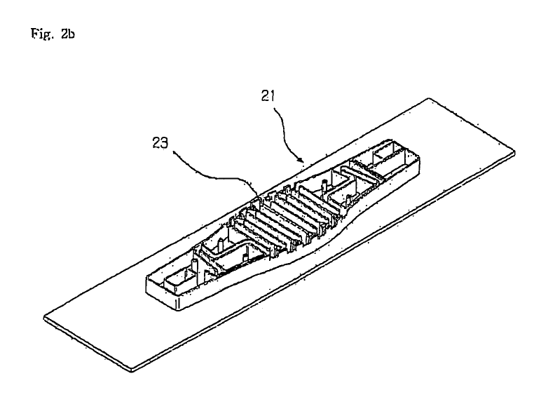

In the stage of manufacturing and preparation (S111), lower mould (1) and upper mould (21) are produced as illustrated in FIG. 2a and FIG. 2b, lower outside skin (33), upper inside skin (35), upper outside skin (37) and insulating paper (39) are cut out as fixed shapes and sizes, and after cutting the elastic tube to a fixed length, mark on the elastic tube the part get caught on the ring of lower mould.

With reference to FIG. 2a, in the above lower mould (1) the place where lower outside skin (31) is arranged is marked, a great number of rings (3) are arranged in upper and lower parts, and a pin (5) is arranged to fix the fixing member (13) of the elastic tube (11). Therefore, the shape of an abdominal belt is determined while elastic tube (11) expanding, according to the arrangement shape of the ring (3).

With reference to FIG. 2b, the heating part (23) of the above upper mould (21) is taken a zigzag shape and adheres the lower outside skin around the elastic tube to upper outside skin, and is shaped not to be adhered to the outside part of ring of lower mould. Please note that the elastic tube should not be adhered to the inside skin by heating thereupon.

The above lower outside skin and upper outside skin are made up of cloth, lower inside skin and upper inside skin are urethane, the above elastic tube is latex hose.

In the stage of arranging material in lower mould (S102), lay insulating paper (31) on the lower mould (1) before everything else as shown in FIG. 2a, arrange lower outside skin (31) and lower inside skin (33) in order in the above insulating paper (39), apply a lubricant (not illustrated) to the above lower inside skin (33), extend elastic tube (11) to the ring (3) of the above lower mould (1) and hang the elastic tube (11) on the above ring (3) for the mark (13) of elastic tube (11) to be located on the above ring (3), apply lubricant to the above elastic tube (11) again, and arrange upper inside skin (350 and upper outside skin (37) in order over the above elastic tube (11).

For the above lubricant, cornstarch can be used and it is for reducing the friction of elastic tube and stimulating slip.

In the stage of separating unfinished product from lower mould (S104), the elastic tube (11) hung on the ring of lower mould as extended state is shrunk to the original length when separating unfinished product from lower mould.

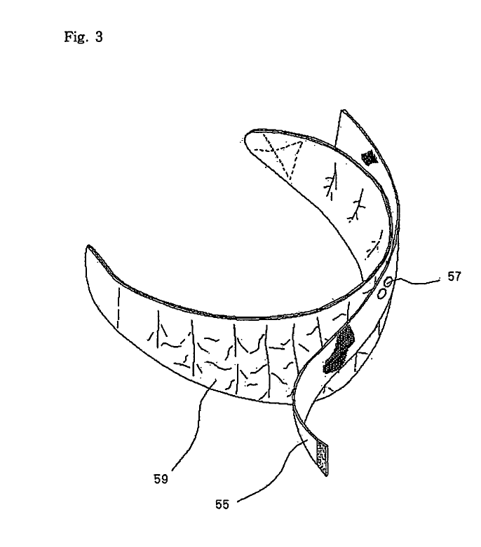

With reference to FIG. 3, in the stage of attaching the enforcement band (55) to a product (59), attach enforcement band (55) to the above product (59) using clamping means (57) including rivet.

The abdominal belt manufactured in this way can be used infusing air into the elastic tube.

As described above, method of manufacturing an abdominal belt and mould according to the invention can prevent an elastic tube from being damaged by adhering outside skin and inside skin together at the same time using attaching method of high frequency, and has effect on mass production since it can simplify attaching process of outside skin.

What is claimed is:

1. Method of manufacturing an abdominal belt is characterized by comprising the stage of manufacturing and preparation (S101) for manufacturing mould and preparing material, arranging stage of material in lower mould produced in the above stage of manufacturing and preparation (S102), binding stage of lower outside skin, lower inside skin, upper inside skin, upper outside skin together by putting the above lower mould into large welding device of high frequency and descending upper mould then heating material by the heating part of high frequency of upper mould (S103), separating stage of mutually adhered unfinished product from lower mould (S104), binding stage of unadhered part in separated unfinished product using a small welding device of high frequency (S105), attaching stage of velcro tape to the above unfinished product (S106), the stage of performing finishing work (S107), and attaching stage of enforcement band to the above product (S108).

2. Method of manufacturing an abdominal belt according to claim 1 is characterized by producing lower mould (1) and upper mould (21) in the above stage of manufacturing and preparation (S101), cutting out lower outside skin (31), lower inside skin (33) upper inside skin (35), upper outside skin (37) and insulating paper (39) to fixed shapes and sizes, marking on the elastic tube the part get caught on the ring of lower mould after cutting the elastic tube to a fixed length.

3. According to claim 1, wherein method of manufacturing an abdominal belt is characterized by laying an insulating paper (39) on a lower mould (1) in arranging stage of material in a lower mould (S102), arranging lower outside skin (31) and lower inside skin (33) in order on the above insulating paper (39), applying a lubricant to the above lower inside skin (33), extending an elastic tube (11) to the ring (3) of the above lower mould (1) and hanging the elastic tube (11) on the above ring (3) for the mark (13) of the elastic tube (11) to be located on the above ring (3), applying a lubricant to the above elastic tube (11) again, and arranging upper inside skin (35) and upper outside skin (37) in order on the above elastic tube (11).

4. Method of manufacturing an abdominal belt according to claim 3, wherein the above lubricant is characterized by corn starch.

5. Mould, wherein it is characterized by a lower mould (1), where lower outside skin (31) is arranged is marked, a great number of rings (3) are arranged in upper and lower parts, a pin (5) is arranged to fix the fixing member (13) of an elastic tube (11), and in upper mould (21), a heating part (23) is taken a zigzag shape, the lower outside skin and upper outside skin around the ring of lower mould are mutually adhered, and the outer part of the ring of a lower mould is formed not to be adhered.
